(19) United States
(12) Patent Application Publication
(10) Pub. No.: US 2005/0114036 A1
(43) Pub. Date: May 26, 2005

(54) Specimen reporting system

(76) Inventors: Ann Fruhling, Gretna, NE (US); Steven Hinrichs, Omaha, NE (US); Anthony Sambol, Omaha, NE (US); Steven Stock, Omaha, NE (US)

Correspondence Address: DILLON & YUDELL LLP, 8911 NORTH CAPITAL OF TEXAS HWY, SUITE 2110, AUSTIN, TX, 78759, US

(21) Appl. No.: 10/723,199

(22) Filed: Nov. 26, 2003

(51) Int. Cl. G06F 19/00

(52) U.S. Cl. 702/19

(57) ABSTRACT

A method, system and computer program product for transportably managing specimen data among specimen collection facilities. In accordance with one embodiment, a management center receives a report from a client terminal. The report includes a sensor-based specimen description and is processed in accordance with a facility identifier corresponding to the specimen collection facility at which the client terminal is located. The facility identity specific processing includes storing the specimen description in association with the facility identifier in a network accessible data storage device. In a further aspect, the specimen report is processed in accordance with a priority level indicator, such that in one embodiment in which the priority level indicator is included with the specimen report, an audio alert signal is triggered in accordance with the level of urgency represented by the priority level indicator.

### BACKGROUND OF THE INVENTION

1. Technical Field

The present invention relates generally to information sharing and networking, and in particular, to providing centralized management and coordination of the collection, processing and dissemination of sensor-based laboratory specimen data. More particularly, the present invention relates to an improved method and system for managing specimen data reporting, enabling efficient assimilation of and responses to sensor-based data gathered from geographically dispersed laboratories or other specimen collection facilities.

2. Description of the Related Art

The acquisition, management, and utilization of public health information is practiced by an array of private and public healthcare organizations that, in addition to being divided into function-specific entities such as laboratories, infection control clinics, hospitals and other organizations, are deployed from geographically dispersed facilities. As such, a coordinated and secure system for managing public health data is necessary to ensure the level of resource sharing and other cooperation between such facilities that is required to meet public health preparedness objectives such as responding to potential epidemics, bioterrorism, and the like, in a timely and integrated manner.

Current attempts to address the need for health data sharing among geographically dispersed facilities include the National Electronic Disease Surveillance System (NEDSS) and the Health Alert Network (HAN). Both the NEDSS program and the HAN are integrated information management and communications systems providing standardization and uniformity in the distribution of health alerts, dissemination of prevention guidelines and other information, distance learning, national disease surveillance, and electronic laboratory reporting. The HAN, which is being developed as part of the Center for Disease Control's (CDC's) Public Health Emergency Preparedness & Response Program, is designed to facilitate high-speed, secure Internet connections to local health officials; provide access to current recommendations, practice guidelines and disease data from the CDC; provide network capacity for rapid and secure communications with first responder agencies; and provide capacity to securely transmit surveillance, laboratory, and other sensitive public health data. The NEDSS program was initiated as a collaboration of national, state and local agencies, along with allied health profession organizations, as a system to improve public health through enhanced sharing and use of public health information.

As currently implemented, both the NEDSS and HAN programs provide health preparedness data processing and transport functions including standards-based specifications for building a coordinated system for sharing urgent public health care information. To this end, the NEDSS and HAN programs implement information technology specifications relating to “live” networking between public health partners; use of electronic clinical data for event detection and management; and management of specimen and lab result data.

While the: foregoing efforts on the part of NEDSS, HAN and other health information sharing programs have facilitated the development of improved health data sharing network systems, there remains a need for improved processing and network tools including mobile networking means that would provide a reliable and integrated forum for the efficient collection, centralized coordination, and dissemination of sensor-based laboratory specimen data. In the case of natural or man-made chemical or biological threats, for example, an electronic surveillance system that shares sample and specimen data among multiple, geographically dispersed laboratory facilities would be of great benefit to the timely diagnostic assessment and reaction planning to such events. Sharing of data among geographically dispersed laboratory facilities is particularly important in providing lab technicians, researchers and medical personnel extended diagnostic and consultation resources.

From the foregoing, it can be appreciated that a need exists for an improved method, system and computer program product for transportably managing sensor-based specimen data among mutually dispersed specimen collection facilities. The present invention addresses such a need.

### SUMMARY OF THE INVENTION

A system, method and program product for managing and reporting specimen data among specimen collection facilities are disclosed herein. In one embodiment, a management center receives a specimen report from a client data processing terminal. The report includes a sensor-based specimen description and is processed in accordance with a facility identifier corresponding to the specimen collection facility at which the client terminal is located. The facility-specific processing includes storing the sensor-based specimen description in association with the facility identifier in a network accessible data storage device. In a further aspect, the received specimen report is processed in accordance with a priority level indicator, such that in one embodiment in which the priority level indicator is included with the received report, a user alert signal is triggered in accordance with the level of urgency represented by the priority level indicator.

All objects, features, and advantages of the present invention will become apparent in the following detailed written description.

### BRIEF DESCRIPTION OF THE DRAWINGS

The novel features believed characteristic of the invention are set forth in the appended claims. The invention itself however, as well as a preferred mode of use, further objects and advantages thereof, will best be understood by reference to the following detailed description of an illustrative embodiment when read in conjunction with the accompanying drawings, wherein:

FIG. 1 is a high-level block diagram representation of a network deploying a sensor-based specimen reporting system in accordance with a preferred embodiment of the present invention;

FIG. 2 is a block diagram representation of a server-side specimen management center in accordance with the present invention;

FIG. 3 is block diagram representation of a specimen report manager implemented by the specimen management center of FIG. 2 in accordance with the present invention;

FIG. 4 is a block diagram representation of a specimen collection client as deployed by the present invention;

FIG. 5 is a flow diagram depicting steps performed during server-side specimen reporting in accordance with one embodiment of the present invention;

FIG. 6 is a flow diagram illustrating steps performed during client-side specimen reporting in accordance with one embodiment of the present invention;

FIG. 7 depicts a client-side specimen reporting user interface in accordance with one embodiment of the present invention; and

FIGS. 8A-8B illustrate server-side specimen reporting user interfaces in accordance with one embodiment of the present invention.

### DETAILED DESCRIPTION OF A PREFERRED EMBODIMENT

The present invention is described in a preferred embodiment in the following description with reference to the figures. While this invention is described in terms of the best mode for achieving this invention's objectives, it will be appreciated by those skilled in the art that variations may be accomplished in view of these teachings without deviating from the spirit or scope of the present invention.

The present invention is directed to the rapid and secure managed sharing of sensor-based specimen data among geographically dispersed public health facilities, such as laboratories, at which specimen data is collected and maintained. The formulation and processing of sensor-based specimen data reports in accordance with the present invention enable timely and integrated responses by laboratory facilities to public health issues pertaining to specimen analysis images, including patients presenting with symptoms, and particularly relating to analysis of microbiological agents, chemicals, fungi, etc. The present invention provides single point network access to specimen report data, enabling networked specimen collection facilities, such as medical or laboratory research facilities having specimen analysis equipment, to interactively share sensor-based specimen data.

The method and system for managing specimen reporting preferably includes program process means for processing incoming specimen data reports in a manner that correlates the text and sensor-based data contained therein with the capacity and specimen handling capabilities of the networked specimen collection facilities. Laboratory rating standards such as the Clinical Laboratory Improvement Amendments (CLIA) or the like, may be stored within a centralized management center to rate each member specimen collection facility. A specimen report manager employs keyword comparison engines, rule-based algorithms, inference engines, neural networks, and other forms of artificial intelligence or correlation programs to match specimen report content with the collection facility ratings to determine which facilities will receive a given specimen report response.

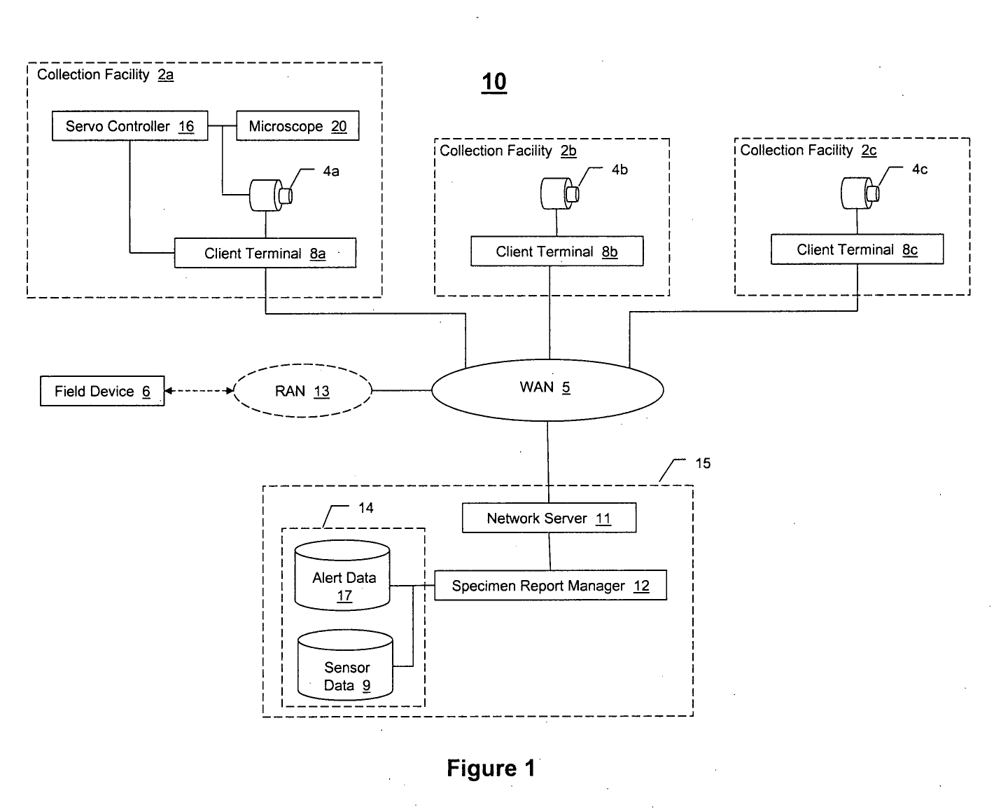

With reference now to the figures wherein like reference numerals refer to like and corresponding parts throughout, and in particular with reference to FIG. 1, there is depicted a high-level block diagram representation of a networked specimen reporting system 10 in accordance with the present invention. In the depicted embodiment, specimen reporting system 10 includes one or more client-side data processing terminals and resident client programs 8a-8c (referred to collectively as “client terminals”) deployed from specimen collection facilities 2a-2c, respectively. Client terminals 8a-8c preferably comprise data processing equipment such as personal computers having processing, storage and input/output functionality suitable for supporting client-side networked computer communications. As utilized herein, a “specimen collection facility” refers to a laboratory, clinic, hospital, office or other mobile or stationary facility characterized as having specimen analysis equipment such as centrifuges, specimen receptacles, microscopes, spectrometers, gas analyzers and the like, for manipulating, processing, isolating or otherwise rendering laboratory specimens in a manner suitable for sensor-based recording such as photography, video recording, radiation imaging, spectrographic viewing, etc.

Specimen reporting system 10 further includes a management center 15 comprising hardware, software and firmware processing modules for managing sensor-based specimen data and related alert messages received from client terminals 8a-8c. Management center 15 communicates with client terminals 8a-8c across a wide area network (WAN) 5 using client-server architecture messaging functionality such as that employed by the World Wide Web. Preferred network configurations for WAN 5 include both proprietary or dedicated networks, as well as open networks, such as the Internet. Although depicted separately from specimen collection facilities 2a-2c, management center 15 may be physically deployed from within one or more of specimen collection facilities 2a-2c without departing from the spirit or scope of the present invention.

Client terminals 8a-8c, forming the client side of specimen reporting system 10, are physically deployed from collection facilities 2a-2c, respectively. The specimen collection facilities represented as blocks 2a-2c are individual, geographically dispersed units such as laboratories, hospitals, and other facilities having specimen analysis and image recording devices, and are communicatively connected by known network coupling means to WAN 5. The specimen collection facilities of the present invention may also include one or more mobile data collection units such as a mobile field device 6, which may be a portable radio frequency (RF) interface data entry and processing device carried on a mobile vehicular platform or otherwise. Field device 6 combines data processing and network communication functionality including a hardware and software communication interface for establishing a connection with WAN 5 via a radio area network 13 using any combination of communication technologies including satellite, cellular, private radio network, fiber optic etc., over which specimen data may be transmitted.

In a preferred embodiment, client terminals 8a-8c are interfaced with specimen sensor devices for capturing and recording specimen characteristics such as X-rays, spectrographic images, photographs, etc., and which may be advantageously included in specimen reports delivered to and from the client terminals. The depicted embodiment utilizes digital cameras 4a-4c as the specimen sensors, enabling the capture of video or still images of specimen samples that have been isolated or otherwise suitably prepared using the resident specimen handling equipment.

Messages and data are exchanged between client terminals 8a-8c and management center 15 using any suitable format, such as in accordance with the Internet Protocol (IP), the Transmission Control Protocol (TCP), or other known network transmission protocols. Moreover, certain of the data may be transmitted or formatted using markup language files using HyperText Markup Language (HTML), extensible Markup Language (XML), or other standard languages.

Management center 15 preferably includes a network server application 11 (a web server when HyperText Transport Protocol (HTTP) is used for messaging) that facilitates client/server messaging and data exchange to and from client terminals 8a-8c, enabling a series of web pages (not depicted) to be viewed via browsers deployed by the client terminals as well as management center 15. In a preferred embodiment, network server 11 and each of client terminals 8a-8c support HTTP and javascript (for client-side modules) and CGI scripts (for server-side modules) applications. Other servers and client side applications, such as browsers, or similar software packages, may be utilized for exchanging data, service requests, messages, and software between the specimen collection and specimen data management processing modules represented as blocks 8a-8c and 15, respectively.

Security over WAN 5 may be implemented using an authentication technique such as Secure Socket Layer (SSL) enabled client/server applications. Firewalls may also be utilized at both the client-side and server-side of specimen reporting system 10 to prevent unauthorized access to data stored at the respective data processing stations. Furthermore, the network connections between client terminals 8a-8c and specimen data manager 15 are preferably established using encryption, encapsulation and other security means to establish a Virtual Private Network (VPN) connection across WAN 5. VPN technology is familiar to those skilled in the art as providing end users a means to securely transport information from a terminal or intranet across a public IP network such as the Internet by establishing a secure tunnel using authentication and encryption techniques.

As explained in further detail below, specimen reporting system 10 employs client-side program processing modules within client terminals 8a-8c and complementary server-side processing modules from management center 15 that cooperatively enable the efficient collection, management and dissemination of sensor-based specimen data. Examples of such sensor-based specimen data include digitized photograph or video data providing a visual representation of a laboratory specimen such as pictures of bodily symptoms and microscopically enhanced images of biological agents, colony morphologies, biochemical reactions, etc.

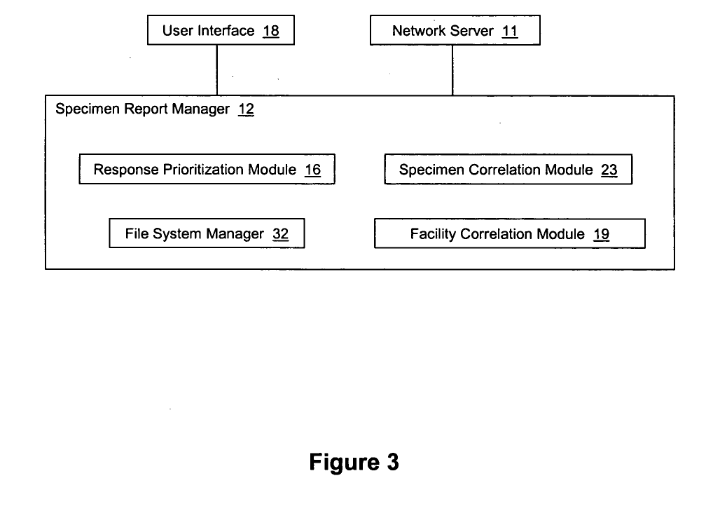

Continuing with FIG. 1, the specimen reports delivered from client terminals 8a-8c to management center 15 are processed by a specimen report manager application 12 that, as explained in further detail with reference to FIG. 3, includes program modules for processing incoming specimen reports to prioritize responses and determine which client-side facilities will receive alert report responses. Specimen report manager 12 further includes file system management program means (depicted in FIG. 3 as file system manager 32) that are utilized to manage sensor-based specimen data 9 and alert report data 17 maintained within a file system 14 and stored on a suitable digital data storage device. In addition to providing file system or database organization, specimen report manager 12 preferably includes file server or database server functionality as implemented by file system manager 32 for managing specimen data requests such as from client terminals 8a-8c.

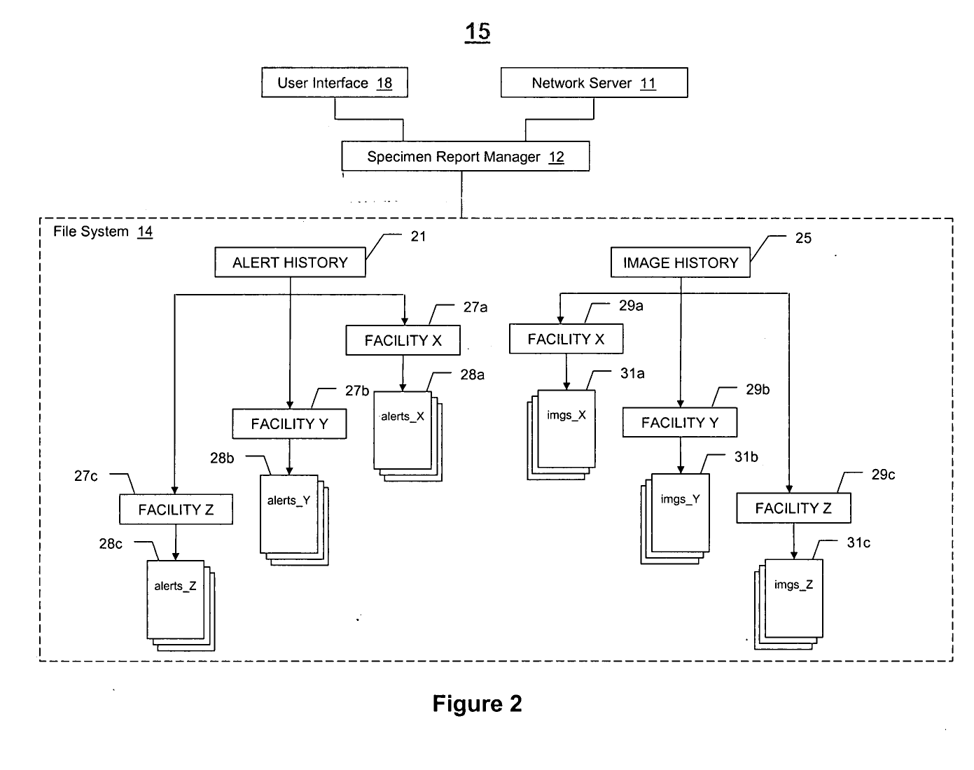

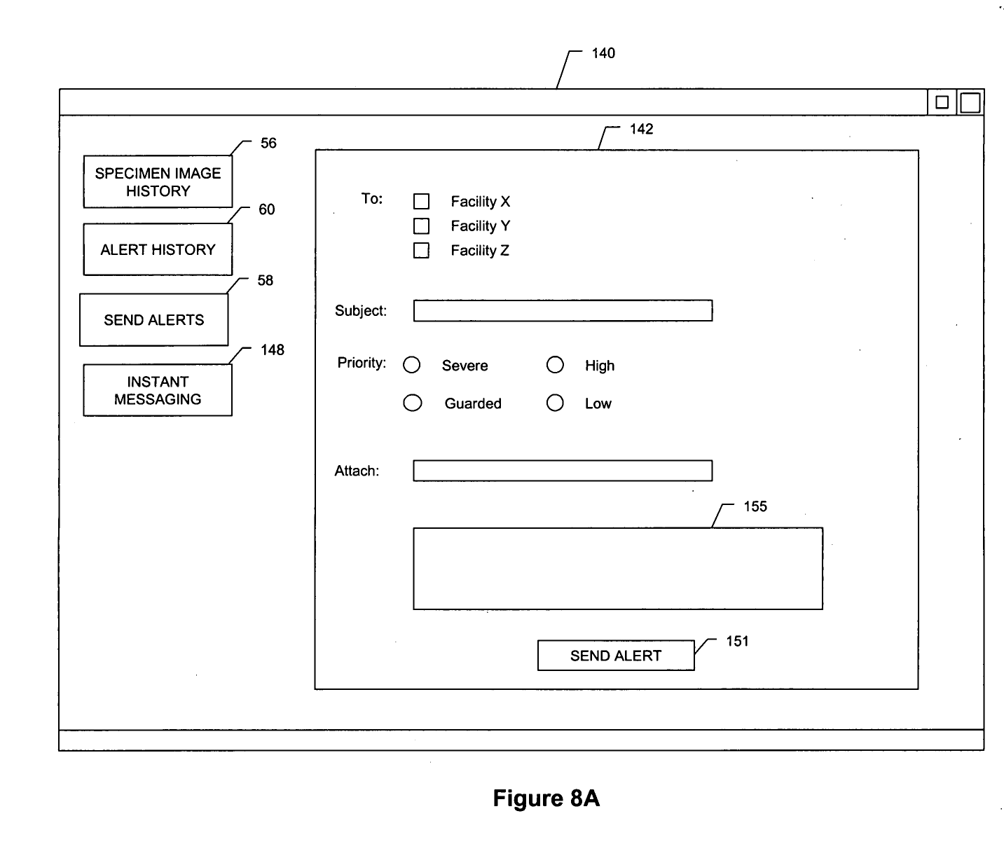

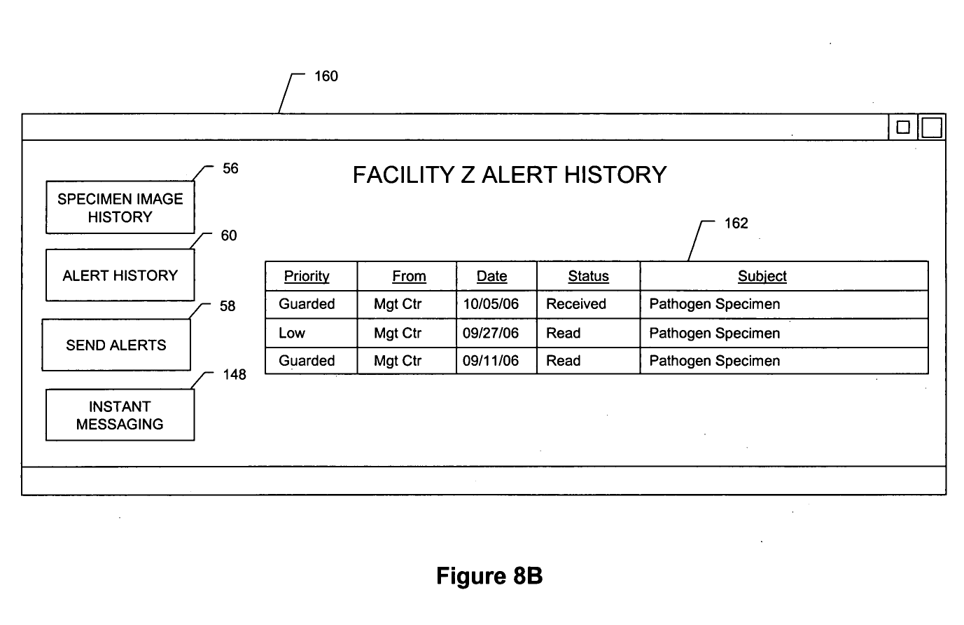

Referring to FIG. 2, there is illustrated a block diagram representation of processing means and program instruction modules constituting server-side management center 15 in accordance with the present invention. Together with standard microprocessor, memory and data storage devices associated with server computer applications, management center 15 includes a user interface 18, comprising local computer user input/output hardware and software interface devices such as, on the input side, a keyboard, pointing device, mouse, touchpad and associated drivers. Also on the input side, user interface 18 comprises one or more graphical user interface (GUI) windows and data entry objects such as those depicted in FIGS. 8A and 8B and described in further detail below. On the output side, user interface 18 may include a display screen, printer, speaker and other devices capable of rendering audio or visual output to a management center user.

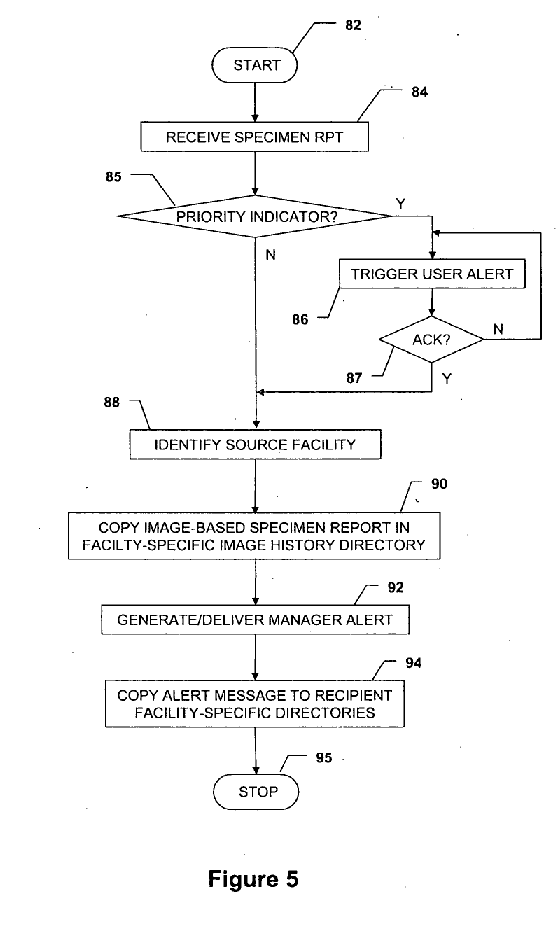

Management center 15 further includes program processing means enabling the generation of system-wide responses, referred to herein as “alert reports,” “manager alerts,” or simply “alerts,” to sensor-based and/or text-based specimen data within the specimen reports received from one or more of the collection facilities. The generation and delivery characteristics of “alert reports,” i.e. informational or instructional reports assembled by management center 15 responsive to specimen reports received from collection facilities, are depicted in further detail with reference to FIGS. 5, 8A and 8B. As part of the alert formulation and issuing process, the data input and processing modules constituting specimen report manager 12 and associated with user interface 18, enable management center 15 to selectively retrieve and process individual specimen reports in accordance with the identity of the specimen collection facility from which the reports were received. In a further aspect shown in FIG. 3, specimen report manager 12 includes program processing means in the form of a specimen correlation module 23 that employs comparison, matching and/or artificial intelligence algorithms to correlate the sensor-based specimen description data contained within different incoming specimen reports, possibly from different originating collection facilities such that, for example, colony morphology microscopy data received in one report is processed in conjunction with patient symptom data received in another specimen report. Such specimen report data cross-correlation may be implemented using keyword-driven correlation or artificial intelligence algorithms such as rule-based algorithms, inference engines, genetic matching algorithms, neural networks, etc.

Referring to FIG. 2, management center 15 receives messages from the specimen collection facilities in the form of electronically transmitted specimen reports that preferably include sensor-based specimen data, such as a digitized photographic image of a specimen, and/or a text-based specimen description or narrative. Exemplary specimen reports, including digital images are represented in FIG. 2 as blocks 31a-31c, and are managed within file system 14 in accordance with a pathname convention specified by specimen report manager 12. Responsive to identifying a received specimen report as originating from a particular collection facility, specimen report manager 12 copies the received specimen report file under an image history directory 25 and into a subdirectory named in accordance with a facility identifier corresponding to the specimen collection facility from which the specimen report was received. In the depicted embodiment, for example, image history directory 25 includes three subdirectories 29a-29c having directory names FACILITY X, FACILITY Y, and FACILITY Z, into which received sensor-based report files 31a-31c are copied, respectively. In a preferred embodiment, the facility-specific subdirectories may be represented within user interface 18 as one or more GUI folders named FACILITY X, FACILITY Y, and FACILITY Z. Furthermore, although not depicted in the figures herein, the specimen description data received with the specimen report may be associated with the respective facility identifiers in one or more database records, such as by using relational database techniques.

In a further aspect of the present invention, user interface 18 and specimen report manager 12 include user interface and program processing means for generating and forwarding manager alerts responsive to data in the received specimen reports. Such manager alerts, alerts_X, alerts_Y and alerts_Z, generated by specimen report manager 12, are delivered by network server 11 to a selected set of recipient facilities and are copied into subdirectories 27a-27c under ALERT HISTORY directory 21 within file system 14. In accordance with the present invention, subdirectories 27a-27c are named in accordance with facility identifiers, FACILITY X, FACILITY Y and FACILITY Z, respectively, identifying the facilities to which the corresponding alerts are delivered. In the manner depicted in FIG. 2, the file/directory organization employed by file system 14 enables independent access to specimen reports received from collection facilities 2a-2c and manager-generated alert data while permitting both the specimen reports and the alerts to be advantageously processed in accordance with the identity of the respective facilities at which the specimen reports are generated or to which the alerts are delivered.

In addition to processing incoming specimen reports in accordance with the sending facility identity, the specimen reporting system of the present further includes data processing and program means for processing incoming specimen reports in accordance with their respective sensor-based and/or text-based content. To this end, and as shown in FIG. 3, specimen report manager 12 includes a response prioritization module 16, a specimen correlation module 23, and a facility correlation module 19. Modules 16, 23 and 19 may include keyword-matching and/or sensor-derived data matching algorithms for determining a priority level of a given incoming report, correlating event related data among two or more reports, and determining to which facilities a given response alert should be delivered. Specifically, response prioritization module 16 filters the specimen report data using keyword-based or rule-based algorithms, inference engines, neural networks, and/or genetic matching algorithms to determine the level of urgency to be associated with the specimen report and whether or not an alert response will be issued from management center 15. In this manner, the prioritization determination triggers further processing of a specimen report, and particularly, whether the report or a subset of its content will be delivered as an alert report to one or more client-side facilities. Although not expressly depicted in the figures, prioritization keywords are preferably stored and accessible by specimen report manager 12 in association with prioritization module 16.

Specimen correlation module 23 is used in processing incoming specimen reports to determine relations, particularly epidemiological relations, between different specimen reports. Similar to response prioritization module 16, specimen correlation module 23 may process the sensor-derived and/or text-based specimen report data using keyword-based or rule-based algorithms, inference engines, neural networks, and/or genetic matching algorithms to determine such inter-report relationships which can subsequently be used in formulating and directing responsive report alerts.

Facility correlation module 19 compares specimen report content with pre-stored collection facility data, such as resource descriptions, CLIA ratings, and the like, to determine which facilities will receive a given specimen report response. Similar to modules 16 and 23, facility correlation module 19 may process the sensor-derived and/or text-based specimen report data using keyword-based or rule-based algorithms, inference engines, neural networks, to determine the appropriate recipient facilities.

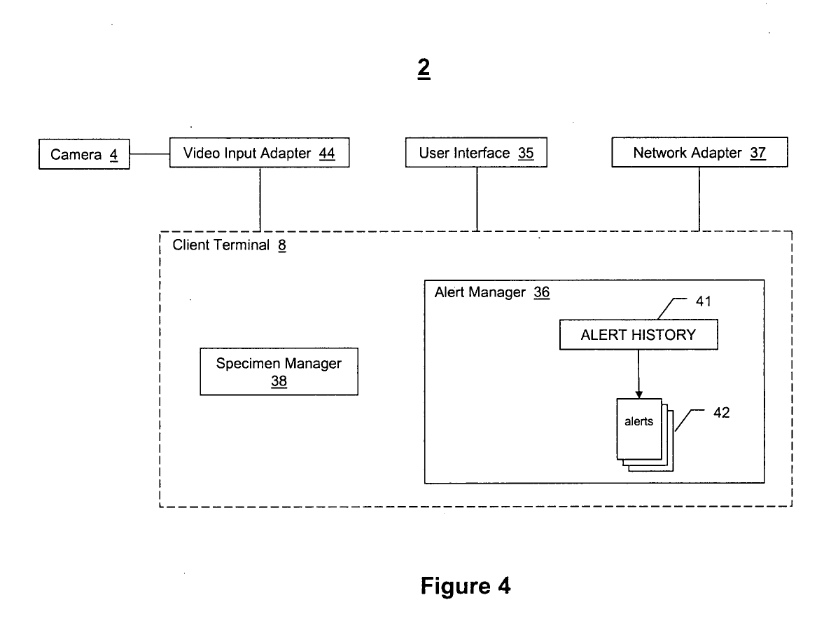

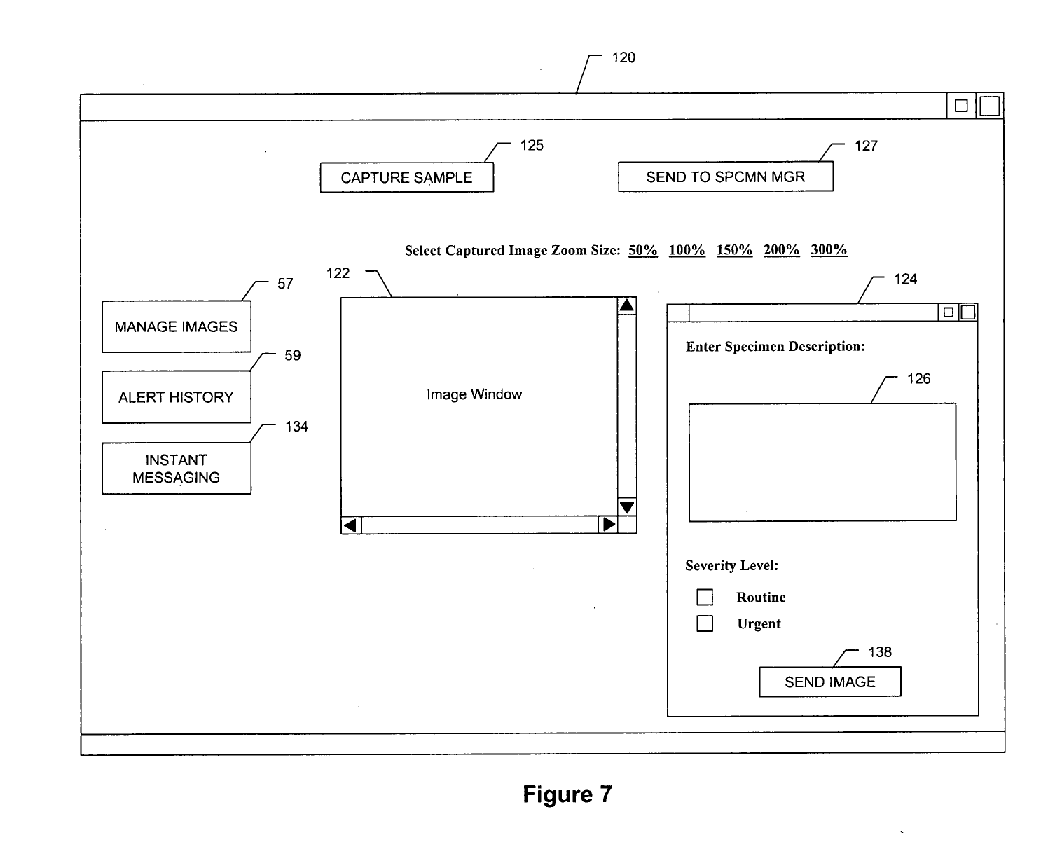

FIG. 4 illustrates a block diagram representation of a client-side specimen collection facility 2, such as one of facilities 2a-2c, in accordance with one embodiment of the present invention. Facility 2, preferably residing within a laboratory having support equipment and systems suitable for collecting, analyzing and recording specimen data, includes a client terminal 8 (such as one of collection clients 8a-8c) having multiple input/output (I/O) interfaces including a video input adapter 44, a user interface 35 and a network adapter 37. Video input adapter 44, which may be a video capture card or other device for converting analog video signals from a video camera into a digital format and storing the digital video in the computer's memory or mass storage device, enables digital image data to be captured and stored within the host client computer from a digital camera 4. User interface 35 comprises local computer user input/output hardware and software interface devices such as, on the input side, a keyboard, pointing device, mouse, touchpad and associated drivers. Also on the input side, user interface 35 comprises one or more GUI windows and data entry objects such as those depicted in FIG. 7 and described in further detail below. On the output side, user interface 35 may include a display screen, printer, speaker and other devices capable of rendering audio or visual output to a client-side user. Network adapter 37, deployable as a network interface card, enables the client side computer deploying client terminal 8 to be connected to a network.

In addition to the standard devices associated with user I/O, video capture, and network communications, client terminal 8 further includes processing and program instruction modules enabling the processing and delivery of captured specimen images in accordance with the specimen report and alert response procedure detailed herein. Specifically, a specimen manager module 38 includes program instruction means for processing user input entered in strategically formulated associations via user input devices within user interface 35 such that specimen reports may be advantageously generated, delivered to management center 15, and stored locally within permanent storage devices.

Referring now to FIG. 7, there is depicted a specimen report setup GUI incorporated deployed from user interface 35 in accordance with one embodiment of the present invention. The report setup GUI is contained within the active operating environment of a client-side specimen management window 120 containing several selectable icon and data entry field objects. In a preferred embodiment, a pointing device (not depicted) is used to select/activate the various objects and data entry fields. A CAPTURE SAMPLE object 125 is used to capture an image of an object specimen via camera 4, wherein the viewing zoom may be controlled and monitored from an image stream window 122. Following capture of a desired specimen image, a button 127 is selected to deliver the captured image to specimen manager 38. As further depicted in FIG. 7, the report setup GUI further includes zoom size options to determine the optimum size and resolution of the captured image. A specimen description window 124 includes a user-selectable text entry field 126 for inputting a narrative description of the captured sample, a pair of priority indicators, Routine and Urgent, for specifying the estimated threat severity of the sample, and a SEND IMAGE button 138 is selected to trigger delivery of the specimen report by collection client 8.

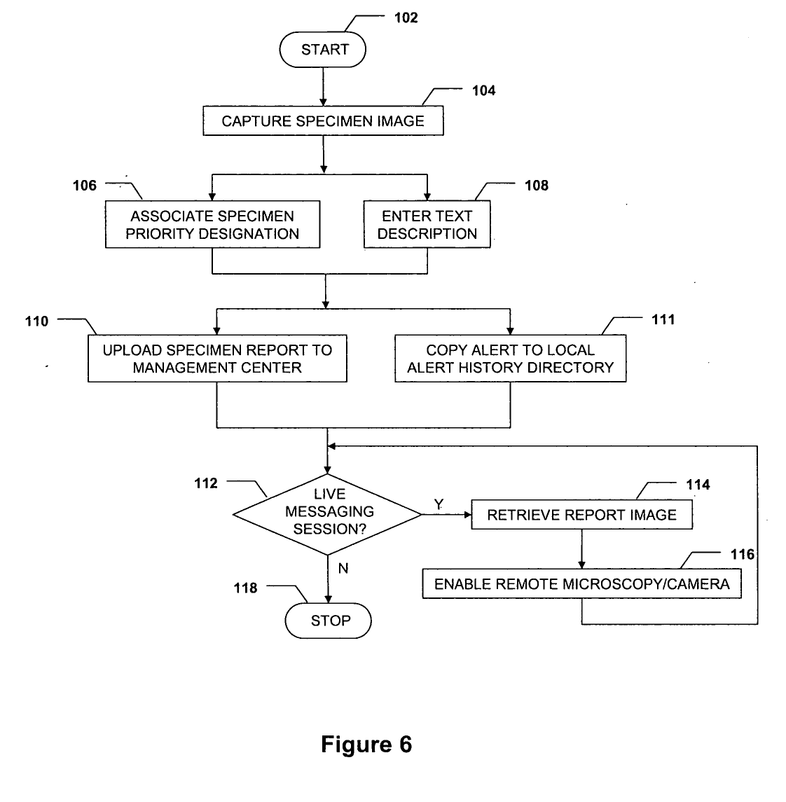

Returning to FIG. 4, client terminal 8 further includes an alert manager program application or module 36. Alert manager 36 includes a file system organized into one or more alert history directories 41 for storing specimen alert reports 42 received by client terminal 8 from management center 15. Such specimen alert reports, or “alerts,” are accessible using the ALERT HISTORY button 59 within specimen management window 120 and are processed and managed as explained in further detail with reference to the specimen reporting process depicted in FIG. 6.

Referring to FIG. 5, there is illustrated a flow diagram depicting steps performed during server-side specimen reporting management in accordance with one embodiment of the present invention. The process begins as shown at step 82 and proceeds to step 84 with a sensor-based specimen report, such as one of reports 31a-31c being received as an uploaded file by network server 11 from a given client terminal. The specimen report is first processed by specimen report manager 12 to determine priority status information and identify the report accordingly as either a routine sensor-based specimen report or a higher priority specimen report having an associated alert message. To this end, a priority status determination is made for the incoming specimen report as illustrated at step 85. As explained in further detail with reference to FIGS. 6 and 7, the received specimen report preferably includes an express priority indicator representing a level of reporting urgency. In the alternative, prioritization module 16 can be used to determine the priority level in accordance with sensor-based or text-based data within the received specimen report. If such a priority indicator is included in the received specimen report or is determined by prioritization module 16, an audio alarm is triggered (step 86) until the alarm is acknowledged by a user via server-side user interface 18 (step 87).

Proceeding as illustrated at step 88, the identity of the specimen collection facility from which the specimen report was received is determined. Determining the identity of the sending facility may be accomplished in a variety of ways. In one embodiment, the specimen report is sent as a network transportable data stream that, in addition to the specimen description data, further includes a facility identifier in the form of a coded data field. In an alternate embodiment, the facility identity is determined by translating network transport information such as the IP address of the sending device. The identification at step 88 is then utilized to select or generate a correct pathname under which the received specimen report will be copied and stored as illustrated at step 90. Although not expressly depicted in the figures herein, the specimen report is preferably stored in association with the priority indicator detected at step 85 such as in the file system structure shown in FIG. 2 or an analogous database record structure.

Following receipt and processing of the specimen report in accordance with the corresponding facility identifier, a specimen alert may be generated and delivered to selected recipient facilities as illustrated at step 92. Referring to FIG. 8A in conjunction with step 92, there is illustrated an alert setup GUI for facilitating the formulation of an alert in accordance with a received specimen report. The alert setup GUI is contained within the active operating environment of a server-side specimen management window 140 containing several selectable icon and data entry field objects. In a preferred embodiment, a pointing device (not depicted) is used to select/activate the various objects and data entry fields including that displayed under the user-selectable text entry field Attach, which is used to identify a specimen report file to be included with the alert. Among the selectable icons is a SEND ALERT button 151 that triggers generation and delivery of the alert to one or more of a list of facilities including Facility X, Facility Y, and Facility Z preferably pre-specified in accordance with the processing of received specimen report data by specimen report modules 16, 23, and 19. Alert setup window 142 further includes multiple selectable priority levels including Severe, High, Guarded, and Low that may be selected in accordance with the prioritization algorithms deployed by prioritization module 16 to associate a given level of urgency to the alert report. To accommodate information regarding a user's assessment or opinion regarding the object specimen, a narrative description may be entered within user-selectable field 155. A list of delivered alerts such as that for FACILITY Z illustrated in FIG. 8B, may be displayed by selecting an ALERT HISTORY button 60.

As part of the alert delivery procedure, and as shown at step 94, the alert message is copied to one or more facility-specific directories such as those depicted in FIG. 3 and the process terminates as shown at step 95.

Referring to FIG. 6, there is illustrated a flow diagram depicting steps performed by client terminal 8 during client-side specimen data management in accordance with one embodiment of the present invention. The process begins as shown at step 102 and proceeds to step 104 with the capture of a specimen image using the video input equipment depicted in FIGS. 1 and 4. Next, as shown at steps 106 and 108, text description is entered in association with the specimen image and a specimen priority designation is entered in association with the report. The entered priority designation may be included in the delivered specimen report as a set flag or specified value in a specified data field. Proceeding to steps 110 and 111, the image-based specimen report is uploaded to management center 15 and a copy of the report is stored in the local alert history directory 41.

As illustrated at inquiry step 112 and steps 114 and 116, the sending client may optionally engage in a live messaging session with the recipient management center 15 using instant messaging functionality. As part of the instant messaging option of the present invention, the image captured at step 104 may be retrieved and viewed by one or more of the instant messaging participants as shown at step 114. Furthermore, as depicted at step 116, the client may advantageously enable remote control of microscopy/camera equipment via suitable remote interface means and the process concludes as illustrated at step 118. For example, and referring back to FIG. 1 collection facility 2a further includes a remote specimen viewing control interface in the form of a servo controller 16 that controls the positioning, focus, lighting and other operational parameters associated with a microscope 20 in accordance with remote commands received by collection client 8a from management center 15.

Preferred implementations of the invention include implementations as a computer system programmed to execute the method or methods described herein, and as a program product. According to the computer system implementation, sets of instructions for executing the method and system of the present invention are resident in a storage device such as the ROM or RAM of one or more computer systems. Until required by the computer system, the set of instructions may be stored as a computer-program product in another computer data storage device such as a disk drive which may include a removable storage media such as an optical disk or floppy disk for eventual utilization in the disk drive.

While this invention has been described in terms of several embodiments, it is contemplated that alterations, permutations, and equivalents thereof will become apparent to one of ordinary skill in the art upon reading this specification in view of the drawings supplied herewith. It is therefore intended that the invention and any claims related thereto include all such alterations, permutations, and equivalents that are encompassed by the spirit and scope of this invention.

1. A method for managing specimen data among specimen collection facilities, said method comprising:
receiving a specimen report from a client terminal; and
processing the specimen report in accordance with a facility identifier corresponding to the specimen collection facility at which the client terminal is located, said processing including storing the specimen description in association with the facility identifier in a network accessible data storage device.

2. The method of claim 1, wherein the specimen report comprises a specimen description including sensor-based specimen data, said method further comprising processing the sensor-based specimen data in accordance with a prioritization algorithm to determine a priority level.

3. The method of claim 2, further comprising initiating an instant messaging session in response to the determined priority level.

4. The method of claim 2, further comprising storing prioritization keywords in association with the prioritization algorithm.

5. The method of claim 2, further comprising forwarding data received in the specimen report to at least one of the specimen collection facilities in accordance with the determined priority level.

6. The method of claim 1, further comprising:
storing a resource rating in association with at least one of the client terminals; and
delivering data received in the specimen report to at least one of the client terminals in accordance with the resource rating.

7. A system for managing specimen data among specimen collection facilities, said system comprising:
means for receiving a specimen report from a client terminal; and
processing means for processing the specimen report in accordance with a facility identifier corresponding to the specimen collection facility at which the client terminal is located, said processing including storing the specimen description in association with the facility identifier in a network accessible data storage device.

8. The system of claim 7, wherein the specimen report comprises a specimen description including sensor-based specimen data, said system further comprising means for processing the sensor-based specimen data in accordance with a prioritization algorithm to determine a priority level.

9. The system of claim 8, further comprising data storage means for storing prioritization keywords in association with the prioritization algorithm.

10. The system of claim 8, further comprising means for forwarding data received in the specimen report to at least one of the specimen collection facilities in accordance with the determined priority level.

11. The system of claim 7, further comprising:
data storage means for storing a resource rating in association with at least one of the client terminals; and
means for delivering data received in the specimen report to at least one of the client terminals in accordance with the resource rating.

12. A computer program product residing on a computer-readable medium for managing specimen data among specimen collection facilities, said computer program product having computer-executable instructions for performing a method comprising:
receiving a specimen report from a client terminal; and
processing the specimen report in accordance with a facility identifier corresponding to the specimen collection facility at which the client terminal is located, said processing including storing the specimen description in association with the facility identifier in a network accessible data storage device.

13. The computer program product of claim 12, wherein the specimen report comprises a specimen description including sensor-based specimen data, said method further comprising processing the sensor-based specimen data in accordance with a prioritization algorithm to determine a priority level.

14. The computer program product of claim 13, wherein said method further comprises initiating an instant messaging session in response to the determined priority level.

15. The computer program product of claim 13, wherein said method further comprises forwarding data received in the specimen report to at least one of the specimen collection facilities in accordance with the determined priority level.

16. The computer program product of claim 12, said method further comprising:
storing a resource rating in association with at least one of the client terminals; and
delivering data received in the specimen report to at least one of the client terminals in accordance with the resource rating.

17. A method for managing specimen data reporting among specimen collection facilities, said method comprising:
receiving a specimen report from a client terminal, wherein the specimen report comprises a specimen description including specimen image data; and
processing the specimen report in accordance with a facility identifier corresponding to the specimen collection facility at which the client terminal is located, said processing including storing the specimen description in association with the facility identifier in a network accessible data storage device.

18. The method of claim 17, wherein said storing the specimen description in association with the facility identifier comprises copying the specimen description data into one or more file directories having directory names corresponding to the facility identifier.

19. The method of claim 18, wherein the one or more file directories are represented as graphical user interface folders.

20. The method of claim 17, wherein said storing the specimen description in association with the facility identifier comprises associating the specimen description with the facility identifier in one or more database records.

21. The method of claim 18, wherein the specimen image data is contained in one or more digital image files, said copying the specimen description into one or more file directories further comprising copying the one or more digital image files into a digital image library directory, the digital image library directory having a directory name corresponding to the facility identifier.

22. The method of claim 17, wherein the received specimen report further includes a priority level indicator, said method further comprising processing the received specimen report in accordance with the priority level indicator.

23. The method of claim 22, wherein the priority level indicator included with the specimen report is selected from among priority level indicia representing levels of urgency associated with the specimen report, said processing the received specimen report in accordance with the priority level indicator comprising triggering an audio alert signal in accordance with the level of urgency represented by the priority level indicator included with the received specimen report.

24. The method of claim 22, wherein said processing the received specimen report in accordance with the priority level indicator comprises storing the specimen report in association with the priority level indicator in a network accessible data storage device.

25. The method of claim 24, wherein said storing the specimen report in association with the priority level indicator comprises associating the priority level indicator with the specimen report in one or more database records.

26. The method of claim 17, further comprising assigning a priority level designation to the received specimen report.

27. The method of claim 26, further comprising:
determining an epidemiological threat level in accordance with the specimen description; and
assigning the priority level designation to the received specimen report in accordance with the determined epidemiological threat level.

28. The method of claim 26, further comprising delivering an alert message to at least one other specimen collection facility, wherein the alert message includes the specimen description associated with the facility identifier and the priority level designation.

29. The method of claim 28, further comprising, responsive to said delivering an alert message to at least one other specimen collection facility, storing an alert message status record.

30. A system for managing specimen data reporting among specimen collection facilities, said system comprising:
means for receiving a specimen report from a client terminal, wherein the specimen report comprises a specimen description including specimen image data; and
processing means for processing the specimen report in accordance with a facility identifier corresponding to the specimen collection facility at which the client terminal is located, said processing including storing the specimen description in association with the facility identifier in a network accessible data storage device.

31. The system of claim 30, wherein said processing means for processing the specimen report in accordance with a facility identifier comprises means for copying the specimen description data into one or more file directories having directory names corresponding to the facility identifier.

32. The system of claim 31, wherein the one or more file directories are represented as graphical user interface folders.

33. The system of claim 30, wherein said processing means for processing the specimen report in accordance with a facility identifier comprises means for associating the specimen description with the facility identifier in one or more database records.

34. The system of claim 31, wherein the specimen image data is contained in one or more digital image files, said means for copying the specimen description into one or more file directories further comprising means for copying the one or more digital image files into a digital image library directory, the digital image library directory having a directory name corresponding to the facility identifier.

35. The system of claim 30, wherein the received specimen report further includes a priority level indicator, said system further comprising means for processing the received specimen report in accordance with the priority level indicator.

36. The system of claim 35, wherein said means for processing the received specimen report in accordance with the priority level indicator comprises means for storing the specimen report in association with the priority level indicator in a network accessible data storage device.

37. The system of claim 36, wherein said means for storing the specimen report in association with the priority level indicator comprises means for associating the priority level indicator with the specimen report in one or more database records.

38. The system of claim 30, further comprising means for assigning a priority level designation to the received specimen report.

39. The system of claim 38, further comprising:
means for determining an epidemiological threat level in accordance with the specimen description; and
means for assigning the priority level designation to the received specimen report in accordance with the determined epidemiological threat level.

40. The system of claim 38, further comprising means for delivering an alert message to at least one other specimen collection facility, wherein the alert message includes the specimen description associated with the facility identifier and the priority level designation.

41. The system of claim 40, further comprising means responsive to said delivering an alert message to at least one other specimen collection facility, for storing an alert message status record.

42. A graphical user interface including a display and a selection device for generating and delivering a specimen report, said graphical user interface comprising:
a specimen image window for obtaining and viewing a specimen image;
a capture sample object for capturing the specimen image displayed in the specimen image window;
a text description data entry field for describing the specimen image; and
a specimen report delivery object for triggering network delivery of the specimen image in association with the text description.

43. The graphical user interface of claim 42, further comprising at least one threat severity threat indicator objects for associating an estimated threat severity to the specimen report.

44. A graphical user interface including a display and a selection device for generating and delivering a specimen alert report, said graphical user interface comprising:
at least one facility selection object for selecting one or more facilities to which the specimen alert report will be transmitted;
at least one priority indicator for indicating the priority level of the specimen alert report; and
a text field for inputting a narrative description in association with the specimen alert report.

45. The graphical user interface of claim 44, wherein said facility selection object comprises one or more objects associated with corresponding one or more specimen collection facilities.
